(19) United States
(12) Patent Application Publication
(10) Pub. No.: US 2014/0364524 A1
(43) Pub. Date: Dec. 11, 2014

(54) METHOD FOR PRODUCING EXPANDABLE STYRENE POLYMERS CONTAINING GRAPHITE AND FLAME RETARDANT

(71) Applicant: BASF SE, Ludwigshafen (DE)

(72) Inventors: Frank Braun, Ludwigshafen (DE); Patrick Spies, Neustadt (DE); Sabine Fuchs, Mannheim (DE); Rainer Ostermann, Luwigshafen (DE); Andreas Kleinke, Heidelberg (DE); Klaus Hahn, Kirchheim (DE)

(21) Appl. No.: 14/367,253

(22) PCT Filed: Dec. 12, 2012
(86) PCT No.: PCT/EP2012/075150

§ 371 Date: Jun. 20, 2014

(30) Foreign Application Priority Data
Dec. 21, 2011 (EP) 11194869.1

(51) Int. Cl. C08F 2/44; C08F 2/18

(52) U.S. Cl. CPC C08F 2/44; C08F 2/18
USPC 521/118; 521/121

(57) ABSTRACT

A process for producing expandable styrene polymers via polymerization of at least one vinylaromatic monomer in aqueous suspension in the presence of at least one halogenated polymer as flame retardant, graphite, and blowing agent, which comprises the presence, in the aqueous suspension at the start of the polymerization reaction, of from 1 to 30% by weight of at least one styrene polymer, based on the entirety of monomers and styrene polymer, and likewise the presence of at least one halogenated polymer as flame retardant in the styrene polymer used at the start of the polymerization reaction.

The present invention relates to a process for producing expandable styrene polymers which comprise graphite and which comprise flame retardant and which have low water content, via polymerization in aqueous suspension.

The provision of flame retardants to polymer foams is important for a wide variety of applications, an example being molded polystyrene foams made of expandable polystyrene (EPS) or extruded polystyrene foam sheets (XPS) for insulating buildings. The compounds used hitherto for homo- and copolystyrenes here are mainly halogen-containing, in particular brominated, organic compounds. However, many of these low-molecular-weight brominated substances, and in particular hexabromocyclododecane (HBCD), are the subject of discussion in relation to damage that they may cause to the environment and to health.

The amounts of halogen-free flame retardants that have to be used in order to achieve the same flame-retardant effect as halogen-containing flame retardants is generally markedly higher. It is therefore frequently the case that halogen-containing flame retardants that can be used with thermoplastic polymers, such as polystyrene, cannot be used with polymer foams, because they either disrupt the foaming process or affect the mechanical and thermal properties of the polymer foam. The large amounts of flame retardant can moreover reduce the stability of the suspension when expandable polystyrene is produced via suspension polymerization.

WO 2007/058736 describes thermally stable, brominated butadiene-styrene copolymers as alternative flame retardant to hexabromocyclododecane (HBCD) in styrene polymers and in extruded polystyrene foam sheets (XPS).

WO 2011/073141 describes flame-retardant polymer foams which comprise, as flame retardant, at least one halogenated polymer, for example brominated polystyrene or styrene-butadiene block copolymers having bromine content in the range from 40 to 80% by weight, and which can comprise infrared absorbers, such as graphite, in order to reduce thermal conductivity.

Because of variations in fire behavior and variations in fire tests, it is often impossible to predict how the flame retardants used with thermoplastic polymers will behave in polymer foams.

U.S. Pat. No. 3,956,203 discloses a process for the production of particulate expandable styrene polymers via polymerization of styrene in the presence of a blowing agent and of from 0.001 to 0.1% by weight of a brominated oligomer. The addition of the brominated oligomer as mold-release agent can markedly reduce the dwell time in molding machines. There can be no flame-retardant action when amounts added are as small as these.

Addition of graphite as infrared absorber gives expandable styrene polymers which can be processed to give thermal insulation materials with improved thermal insulation at low densities (EP-A 981 575). Thermal conductivity here is markedly reduced via a reduction in the amount of infrared. Other IR absorbers, such as carbon black, silicates, and aluminum, can achieve similar improvements.

Polymerization in the presence of surfactant additives, such as particulate IR absorbers or flame retardants, is often problematic because said additives destabilize the suspension and can cause coagulation. WO 99/16817 and WO 03/033579 therefore propose, for suspension polymerization in the presence of graphite particles, use of specific peroxide initiators, such as tert-butyl 2-ethylperoxyhexanoate, which do not form any benzoyl radicals or benzyl radicals, or different peroxides with different decomposition temperatures, and the use of a solution of polystyrene in styrene at the start of the suspension polymerization reaction.

The economics of this process require that it recycles marginal fractions of the expandable styrene polymers with very high or very low particle diameters, and recirculates these after dissolution in styrene in the form of what are known as “starter mixtures” in subsequent reaction batches. The dissolution of marginal fractions in the suspension process in the presence of halogenated flame retardant, in particular hexabromocyclododecane (HBCD) can drastically increase the water content of the expandable styrene polymers.

WO 2007/101805 discloses a process for producing expandable styrene polymers with narrow bead size distribution via polymerization in aqueous suspension in the presence of a volatile blowing agent and from 0.1 to 30 ppm, based on the organic phase, of a hydroxyalkylamine. These can be processed to give foams with homogeneous cell structure.

WO 02/055594 describes expandable polystyrene particles which comprise graphite particles or carbon black particles and also, as blowing agent, from 2.2 to 6% by weight of pentane and from 1 to 10% by weight of water. These exhibit good expandability at comparatively low pentane content.

Addition of flame retardants, such as brominated polystyrenes or styrene-butadiene block copolymers and simultaneous addition of amounts of more than 1 percent by weight of graphite particles also often gives unstable suspensions with phase inversion during the polymerization reaction. Control of bead size distribution is markedly more difficult, and larger amounts of stabilizer are needed. The internal water content of the resultant expandable styrene polymers is often excessive, and has to be reduced by lengthy and energy-consuming drying steps. A lengthy drying step can also cause significant losses of blowing agent from the expandable polystyrene particles.

WO 2011/133035 describes foam moldings made of expandable polystyrene and of recycled polystyrene particles from previously foamed moldings. The foam moldings made of expandable polystyrene can comprise inter alia additives such as graphite as IR absorber and brominated polymers, in particular brominated polystyrene as flame retardant, and this statement also applies to the recycled polystyrene particles.

It was an object of the present invention to eliminate the disadvantages mentioned and to discover a process which can produce expandable styrene polymers which comprise graphite and which comprise flame retardant and which have low water content, via polymerization in aqueous suspension. By virtue of the low water content it is possible to avoid lengthy and energy-consuming drying steps.

The object was achieved via a process with the features according to claim 1.

Preferred embodiments can be found in the dependent claims.

Expandable styrene polymers (EPS) are styrene polymers comprising blowing agent.

Styrene polymers that can be used are homopolymers or copolymers made of styrene, of styrene derivatives, or of copolymerizable ethylenically unsaturated monomers. These are formed via suspension polymerization of styrene and of the appropriate copolymerizable monomers, for example alkylstyrenes, divinylbenzene, 1,4-butanediol dimethacrylate, para-methyl-α-methylstyrene, α-methylstyrene or acrylolnitrile, butadiene, acrylate, or methacrylate.

It is preferable to use styrene as vinylaromatic monomer.

The suspension polymerization of styrene is known per se. It has been described in detail in Kunststoff-Handbuch [Plastics handbook], volume V, “Polystyrol” [Polystyrene], Carl Hanser-Verlag, 1969, pp. 679 to 688. The general procedure here suspends styrene, optionally together with the abovementioned comonomers, in water and polymerizes the mixture to completion in the presence of organic or inorganic suspension stabilizers. The ratio by volume of water to organic phase is preferably from 0.5 to 1.6, in particular from 1.0 to 1.4.

Carbon particles used can be various natural or synthetic carbon blacks or graphites. It is preferable that the carbon particles comprise a proportion of at least 1% by weight, preferably at least 5% by weight, of graphitic structures. It is preferable that the ash content of the carbon particles, determined in accordance with DIN 51903, is from 0.005 to 15% by weight, preferably from 0.01 to 10% by weight. It is particularly preferable to use graphite particles with average particle size in the range from 1 to 50 μm.

The graphite preferably used preferably has an average particle size of from 1 to 50 μm, in particular from 2.5 to 12 μm, a bulk density from 100 to 500 g/l, and a specific surface area from 5 to 20 m²/g. Natural graphite or ground synthetic graphite can be used.

The proportion of the entirety of all of the carbon particles is preferably in the range from 0.1 to 10 percent by weight, in particular from 1 to 6 percent by weight, based on styrene polymer.

Carbon particle used can also comprise silane-modified carbon particles which by way of example have been modified with from 0.01 to 1% by weight of silane, preferably with from 0.1 to 0.5% by weight, based on the carbon particles.

The silane-modified carbon particles preferably have C₃-C₁₆-alkylsilane groups or arylsilane groups at their surface, in particular C₆-C₁₂-alkylsilane groups or phenylsilane groups. Particularly suitable materials for modifying the carbon particles are alkyl- or arylsilanes having from 1 to 3 halogen atoms or methoxy groups on the silicon atom. It is preferable to use C₃-C₁₆-alkylsilanes, or arylsilanes, in particular octyltrichlorosilane, chloro(dodecyl)dimethylsilane, hexadecyltrimethoxysilane, or phenyltrichlorosilane.

The modification with silanes causes hydrophobization of the surfaces of the carbon particles via silyl groups, thus markedly reducing the interfacial activity of the carbon particles which is disruptive in the suspension process. Surprisingly, the process known per se for hydrophobizing hydrophilic surfaces via silylation in the gas phase or in solvents, such as toluene, also functions in the case of graphite, which is a relatively hydrophobic material, to mask residual polar groups. The surface-modification of the carbon particles permits better compatibility with, or indeed coupling to, the polymer matrix.

In stage a), the usual additional substances can be added in addition to the particulate additives, examples being flame retardants, nucleating agents, UV stabilizers, chain-transfer agents, plasticizers, pigments, and antioxidants.

The usual additional substances can be added in addition to the particulate additives, examples being flame retardants, nucleating agents, UV stabilizers, chain-transfer agents, plasticizers, pigments, and antioxidants.

The amount generally used of the halogenated polymers is in the range from 0.2 to 25% by weight, preferably in the range from 1 to 15% by weight, based on the monomers. In particular in the case of foams made of expandable polystyrene, adequate flame retardancy is achieved by using amounts of from 5 to 10% by weight, based on the polymer foam.

Preferred additional substances used are halogenated or halogen-free flame retardants. Particularly suitable materials are organic, in particular aliphatic, cycloaliphatic, and aromatic, bromine compounds, such as hexabromocyclododecane (HBCD), pentabromo-monochlorocyclohexane, pentabromophenyl allyl ether, or brominated styrene polymers, such as styrene-butadiene block copolymers, which can be used alone or in the form of a mixture. It is preferable to use, as flame retardant, exclusively brominated styrene polymers or brominated styrene-butadiene block copolymers.

The average molecular weight of the halogenated polymer used as flame retardant is preferably in the range from 5000 to 300,000, in particular from 30,000 to 150,000, determined by means of gel permeation chromatography (GPC).

The weight loss of the halogenated polymer in thermogravimetric analysis (TGA) is 5% by weight at a temperature of 250° C. or higher, preferably in the range from 270 to 370° C.

A preferred halogenated polymer as flame retardant is brominated polystyrene or styrene-butadiene block copolymer having bromine content in the range from 40 to 80% by weight.

The effect of the bromine-containing flame retardants can be improved via addition of C—C— or O—O-labile organic compounds. Examples of suitable flame retardant synergists are dicumyl and dicumyl peroxide. A preferred combination is composed of from 0.6 to 5% by weight of organic bromine compound and from 0.1 to 1.0% by weight of the C—C— or O—O-labile organic compound.

Blowing agent used usually comprises aliphatic hydrocarbons having from 3 to 10, preferably from 4 to 6, carbon atoms, for example n-pentane, isopentane, or a mixture thereof. The amounts added of the blowing agent are conventional, about 1 to 10% by weight, preferably from 3 to 8% by weight, based on the weight of the styrene polymers present in the expandable styrene polymer.

The suspension polymerization reaction can in particular use, alongside the additives already listed above, the usual peroxide initiators and suspension stabilizers, for example protective colloids, inorganic Pickering salts, and anionic and nonionic surfactants.

It is generally possible to use from 0.1 to 10% of white oil or Hexamoll Dinch as plasticizer, in order to improve the expandability of the final product.

Amounts of from 0.3 to 5% by weight, based on water, of a phosphate can be used to stabilize the aqueous suspension, preferably magnesium pyrophosphate or tricalcium phosphate.

It is preferable to use a phosphate to stabilize the aqueous suspension, particularly magnesium pyrophosphate or tricalcium phosphate. It is particularly preferable to use magnesium pyrophosphate.

Magnesium pyrophosphate is generally used as initial charge at the start of the polymerization reaction, and its concentration used is generally from 0.03 to 2.0% by weight, preferably from 0.05 to 0.5% by weight, and particularly preferably from 0.1 to 0.2% by weight, based on the aqueous phase.

The magnesium pyrophosphate is preferably produced immediately prior to the polymerization reaction via combination of maximum-concentration solutions of pyrophosphate and magnesium ions, using the amount of a magnesium salt stoichiometrically required for the precipitation of Mg₂P₂O₇. The magnesium salt can be in solid form or in aqueous solution. In one preferred embodiment, the magnesium pyrophosphate is produced via combination of aqueous solutions of sodium pyrophosphate (Na₄P₂O₇) and magnesium sulfate (MgSO₄ 7 H₂O). The amount added of the magnesium salt is at least that stoichiometrically required, and is preferably a stoichiometric amount. For the process of the invention it is advantageous to avoid any excess of alkali metal pyrophosphate.

The process of the invention preferably uses emulsifiers which comprise sulfonate groups and are known as extenders. Among said extenders are by way of example sodium dodecylbenzenesulfonate, long-chain alkylsulfonates, vinylsulfonate, and diisobutylnaphthalenesulfonate. Extenders preferably used are alkali metal salts of dodecylbenzenesulfonic acid and/or alkali metal salts of a mixture of C₁₂-C₁₇-alkylsulfonic acids.

A particularly suitable mixture of C₁₂-C₁₇-alkylsulfonates is composed of mainly secondary sodium alkylsulfonates having average chain length C₁₅. A mixture of this type is marketed as Mersolat® K 30 by Bayer AG. The extenders increase the ability of sparingly soluble inorganic compounds to stabilize the suspension.

The amounts generally used of the extenders are from 0.5 to 15% by weight, preferably from 2 to 10% by weight, based on magnesium pyrophosphate.

A factor which has been found to be advantageous for the stability of the suspension is the presence, at the start of the suspension polymerization reaction, of a solution of polystyrene (or of an appropriate styrene copolymer) in styrene (or in the mixture of styrene with comonomers). It is preferable here to start from a solution of strength from 0.5 to 30% by weight, in particular from 3 to 20% by weight, of polystyrene in styrene. It is possible here to dissolve virgin polystyrene in monomers, but it is advantageous to use what are known as marginal fractions, these being excessively large or excessively small beads removed by sieving when the range of beads produced in the production process for expandable polystyrene is divided into fractions.

The polymerization reaction is initiated via conventional styrene-soluble initiators, such as dibenzoyl peroxide, tert-butyl perbenzoate, dicumyl peroxide, di-tert-butyl peroxide, and mixtures of these, preferably in total amounts of from 0.05 to 1% by weight, based on the monomers.

The polymerization reaction is preferably carried out in the presence of from 0.01 to 0.5% by weight, based on the monomers, of a peroxodicarbonate. It is particularly preferable to use dicetyl peroxocarbonate.

In one particular embodiment of the process of the invention, from 0.1 to 2% by weight, preferably from 0.5 to 1% by weight, based on the monomers, of at least one hydroxyalkylamine is metered into the mixture during the polymerization reaction.

It has been found that from 0.1 to 30 ppm, preferably from 1 to 10 ppm, based on the organic phase, of a hydroxyalkylamine is sufficient to give an adequately homogeneous foam structure and, associated therewith, a reduction of up to 2 mW/mK in thermal conductivity.

The hydroxyalkylamine can be added during the production of the aqueous suspension or during the heating phase, preferably before reaching a temperature of 100° C. It is particularly preferable to meter the hydroxyalkylamine into the mixture during the polymerization reaction.

Hydroxyalkylamines preferably used are alkyldi(2-hydroxyethyl)amines, particularly preferably C₁₂/C₁₄-alkyldi(2-hydroxyethyl)amine, which is obtainable commercially as Armostat® 400 from Akzo.

The polymerization reaction is particularly preferably carried out in the presence of

from 0.2 to 25% by weight of at least one halogenated polymer,
from 1 to 10% by weight of graphite, and
from 3 to 8% by weight of at least one C₃-C₇-hydrocarbon as blowing agent,
based in each case on the weight of the styrene polymers present in the expandable styrene polymer.

It is preferable here to use, at the start of the polymerization reaction, a styrene polymer comprising from 0.2 to 25% by weight of at least one halogenated polymer, and from 1 to 10% by weight of graphite.

The expandable styrene polymer particles obtained by the process of the invention can be coated with the usual coating compositions, for example metal stearates, glycerol esters, and fine-particle silicates.

The diameter of the styrene polymer particles produced in the invention and comprising blowing agent is generally from 0.2 to 4 mm. They can be prefoamed by conventional methods, for example with steam, to give foam particles of diameter from 0.1 to 2 cm and of bulk density from 5 to 100 kg/m³.

The prefoamed particles can then be foamed to completion by conventional processes to give foam moldings of density from 5 to 100 kg/m³.

The foams produced from the expandable styrene polymers of the invention feature excellent thermal insulation. This effect is particularly clearly apparent at low densities. The reduction of thermal conductivity is sufficient for compliance with the requirements of thermal conductivity class 035 (in accordance with DIN 18164), part 1, table 4.

The process of the invention has numerous advantages. The particle diameter of the expandable styrene bead polymers can be controlled effectively and precisely. The expandable bead polymers comprising blowing agent have low internal water contents, high expansion capability, and good and constant processing properties.

### EXAMPLES

### Raw Materials Used:

FRT 1 brominated styrene-butadiene diblock copolymer (Mw 56,000, styrene block 37%, 1,2-vinyl content 72%, bromine content 65% by weight, TGA weight loss 5% at 238° C.) produced as in example 8 of WO 2007/058736
HBCD hexabromocyclododecane (comparison)
EPS 1 marginal fraction of an expandable polystyrene comprising graphite and comprising FRT 1
   Intrinsic viscosities IV (0.5% in toluene at 25° C.) were determined in accordance with DIN 53 726
   The fire performance of the foam sheets was determined at a foam density of 15 kg/m³ in accordance with DIN 4102

### Production of a Mg₂P₂O₇ Suspension:

The examples below used a freshly prepared, amorphous magnesium pyrophosphate precipitate (MPP precipitate) as Pickering stabilizer. The Mg₂P₂O₇ suspension was produced in advance for each of the examples below by in each case dissolving 931.8 g of sodium pyrophosphate (Na₄P₂O₇, Giulini) in 32 l of water at room temperature (25° C.). A solution of 1728 g of magnesium sulfate heptahydrate (Epsom salt, MgSO₄×7 H₂O) in 7.5 kg of water was added to the above solution, with stirring, and the mixture was then stirred for 5 minutes. This gave aqueous suspension of magnesium pyrophosphate (MPP).

### Example 1

The organic phase was produced by dissolving 529 g of EPS 1, 52.0 g of flame retardant FR1, 2.08 g of tert-butyl 2-ethylperoxyhexanoate (Trigonox 21S, AkzoNobel), 18.7 g of dicumyl peroxide (Perkadox BC-FF, AkzoNobel), and 2.00 g of white oil (Winog 70) in 3.31 kg of styrene, and suspending 122 g of graphite (UF99.5, Kropfmuhl AG) in the mixture.

4.28 l of demineralized water were used as initial charge in a pressure-tight 12 I stirred tank with crossblade stirrer, and 835 g of the freshly prepared Mg₂P₂O₇ suspension described above were added, with stirring at 170 rpm. The suspension was heated to 95° C. within 1.5 hours and then to 131° C. within 4.2 hours. 110 minutes after a temperature of 80° C. had been reached, 43.8 g of a 2% strength solution of E30 emulsifier (produced from E30-40 from Leuna Tenside GmbH, mixture of C₁₂-C₁₇-sodium alkylsulfonates) were metered into the mixture, and 190 minutes after a temperature of 80° C. had been reached, 222 g of Pentan S (Haltermann/Exxon) were metered into the mixture. Finally, polymerization was completed at a final temperature of 131° C.

The resultant polymer was isolated by decanting, and dried in a stream of air at 60° C. for 7 minutes to remove surface water, and then exposed to the atmosphere at room temperature for 30 minutes. A sieve cut typical for EPS, from 0.8 to 1.4 mm, was extracted by sieving for further processing and testing, and was coated with a coating made of glycerol monostearate, glycerol tristearate, and precipitated silica. The internal water content determined on the EPS beads thus pretreated was 7.0%, and they passed the B2 flame test in accordance with DIN 4102.

### Example 2

Example 1 was repeated, except that the organic phase also comprised 4.16 g of dicetyl peroxodicarbonate (Perkadox 24-FL, AkzoNobel). The 2% strength solution of E30 emulsifier was added 100 minutes after a temperature of 80° C. had been reached. Internal water content was 5.0%. The B2 flame test in accordance with DIN 4102 was passed.

### Example 3

Example 2 was repeated, except that 43.1 g of a 2% strength solution of alkyl(C₁₂-C₁₄)bis(2-hydroxyethyl)amines (Armostat 400, AkzoNobel) were added to the reactor 225 minutes after a temperature of 80° C. had been reached. Internal water content was 2.1%. The B2 flame test in accordance with DIN 4102 was passed.

Table 1 collates the results. The % by weight values are based on styrene monomer used:

TABLE 1

| | | Alkyl(C₁₂-C₁₄)bis(2- | Dicetyl | | |
|---|---|---|---|---|---|
| | | hydroxyethyl)amines | peroxocarbonate | Water content | Fire test B2 |
| Example | Starter | [% by wt.] | [% by wt.] | [% by wt] | (DIN 4102) |
| 1 | EPS 1 | — | — | 7.0 | passed |
| 2 | EPS 1 | — | 0.126 | 5.0 | passed |
| 3 | EPS 1 | 0.0166 | 0.126 | 2.1 | passed |

1.-8. (canceled)

9. A process for producing expandable styrene polymers via polymerization of at least one vinylaromatic monomer in aqueous suspension in the presence of at least one brominated styrene polymer as flame retardant, graphite, and blowing agent, which comprises the presence, in the aqueous suspension at the start of the polymerization reaction, of from 1 to 30% by weight of at least one styrene polymer, based on the entirety of monomers and styrene polymer, and likewise the presence of at least one brominated styrene polymer as flame retardant in the styrene polymer used at the start of the polymerization reaction.

10. The process of claim 9, wherein said vinylaromatic monomer is styrene.

11. The process of claim 9, wherein the polymerization reaction is carried out in the presence of from 0.01 to 0.5% by weight, based on the monomers, of a peroxodicarbonate.

12. The process of claim 9, wherein from 0.1 to 2% by weight, based on the monomers, of at least one hydroxyalkylamine is metered into the mixture during the polymerization reaction.

13. The process of claim 9, wherein said brominated styrene polymer comprises a brominated polystyrene or brominated styrene-butadiene block copolymer having bromine content in the range from 40 to 80% by weight.

14. The process of claim 9, wherein a phosphate is used to stabilize the aqueous suspension.

15. The process of claim 9, wherein the polymerization reaction is carried out in the presence of
from 0.2 to 25% by weight of at least one brominated styrene polymer,
from 1 to 10% by weight of graphite, and
from 3 to 8% by weight of at least one C₃-C₇-hydrocarbon as blowing agent,
based in each case on the weight of the styrene polymers present in the expandable styrene polymer.

16. The process of claim 15, wherein the styrene polymer used at the start of the polymerization reaction comprises
from 0.2 to 25% by weight of at least one brominated styrene polymer, and
from 1 to 10% by weight of graphite.
